(19) United States
(12) Patent Application Publication
(10) Pub. No.: US 2011/0036693 A1
(43) Pub. Date: Feb. 17, 2011

(54) ILLUMINATION BUTTON, ILLUMINATION SWITCH ASSEMBLY, AND BUTTON STRUCTURE HAVING QUICKLY REMOVABLE BUTTON CAP

(76) Inventors: Cheng-Hsuan Lin, Taipei (TW); Yung-Feng Lin, Taipei (TW); Mei-Hui Chen, Taipei (TW)

Correspondence Address: Muncy, Geissler, Olds & Lowe, PLLC, 4000 Legato Road, Suite 310, FAIRFAX, VA, 22033, US

(21) Appl. No.: 12/647,807

(22) Filed: Dec. 28, 2009

(30) Foreign Application Priority Data
Aug. 14, 2009 (TW) 98127356

(51) Int. Cl. H01H 9/00; H01H 13/14

(52) U.S. Cl. 200/314; 200/341

(57) ABSTRACT

An illumination button applied to an illumination switch assembly is provided. The illumination button includes a light guide body and a button cap. The light guide body is disposed in the button cap to press a switch element with a pressing bump and to receive light from a light source with a light receiving structure. The light received by the light receiving structure is guided by the light guide body to leave a top surface of the button cap through a light exiting structure. Two connecting members are disposed on an edge the button cap, wherein the two connecting members provided to be clamped by clamping members disposed on an inner surface of a housing, so as to hold the button cap in a button hole of the housing. Therefore, the button cap is able to be installed to the housing quickly with out using a tool.

### CROSS-REFERENCES TO RELATED APPLICATIONS

This non-provisional application claims priority under 35 U.S.C. §119(a) on Patent Application No. 98127356 filed in Taiwan, R.O.C. on Aug. 14, 2009, the entire contents of which are hereby incorporated by reference.

### BACKGROUND OF THE INVENTION

1. Technical Field

The present invention relates to the illumination of buttons, and more particularly to an illumination button, an illumination switch assembly, and a button structure having a quickly removable button cap.

2. Related Art

A button is usually equipped with a button symbol on a top surface of the button cap, such that a user may rapidly recognize the function corresponding to the button. When an electronic device is operated in poor illumination environment, the user is usually unable to recognize the position of the button and the button symbol on the button rapidly. Therefore, the user cannot correctly operate the button. In order to solve the above problems, in the prior art, various illuminating structures are provided for illuminating the buttons.

A light source providing illumination directly projects light to a center of a button cap, such that an optimal illumination effect is achieved. However, for a switch element to be pressed by the button cap, a good trigger effect is obtained only when the switch element is disposed at a position corresponding to the center of the button cap. In order to make sure that the switch element is triggered correctly, at the position of the light source, the light is usually unable to be directly projected to the center of the button cap. Thus, a light guide element or a diffusion film is required to change a traveling direction of the light, so as to ensure that the light projected by the light source is projected towards a top surface of the button cap. For example, in a “Pressed Key with Lighting Module” disclosed in Taiwan (R.O.C) Invention Patent Publication No. 1239543, a light source and a button cap that can guide light are disposed on a switch circuit board. And a diffusion piece is disposed in the button cap. The button cap covers the light source to receive the light and enable the light to pass through the button cap, thereby illuminating the surface of the button cap. The light guide element or diffusion piece makes the assembly process of the button module relatively complicated.

In addition, usually on the top surface of the button cap, only a part that is configured with the button symbol is light-pervious, thus illuminating the button cap and highlighting the button symbol at the same time. The button cap is usually made of a light-pervious material. After an opaque pigment is sprayed, the pigment at the part corresponding to the button symbol is then removed. However, the additional pigment easily drops off when the button cap is pressed and rubbed, such that the button symbol becomes obscure and indistinguishable.

Moreover, the edges of the button cap are extended to form flexible connecting members in pairs. The flexible connecting members are fixed to the inner side of a housing through welding, such that the button cap is held in a button hole of the housing. With an elastic force provided by the flexible connecting members, the button cap may restore its original position after being pressed. A disadvantage of the welding is that re-work or replacement of the button cap is not convenient, and welding tools are required for installing the button cap. If the button cap is found damaged or with a poor quality outside the factory, the button cap is usually unable to be replaced separately and the entire case has to be replaced. As the button cap is often an element that is damaged most easily or is of poor quality, the button cap fixed through welding increases the cost of subsequent maintenance or quality control.

### SUMMARY

In the prior art, in order to illuminate a button cap effectively, a light guide element or a diffusion piece usually is required to be disposed below the button cap, such that an assembly process of the button is relatively complicated. At the same time, since an illuminating light source cannot irradiate a center of the button cap directly, an illumination effect is relatively poor. Further, the button cap having a partial light-pervious area is fabricated through spray coating, and the coating on a surface abrades and drops off easily, such that a button symbol becomes obscure and indistinguishable.

In order to solve the above problem, the present invention is directed to an illumination button which has a simple structure and a good illumination effect, and prevents the problem of a button symbol becoming obscure due to abrasion.

In one or more embodiments, the present invention provides an illumination button. The illumination button includes a light guide body and a button cap. The light guide body is made of light-pervious material, and has a top surface, a bottom surface, a protrusive light exiting structure, a protrusive pressing bump, and a protrusive light receiving structure. The light exiting structure is formed on the top surface, and the protrusive pressing bump and the protrusive light receiving structure are formed on the bottom surface. The light receiving structure has a light receiving surface for receiving light, such that the light is guided and exits the light guide body through the light exiting structure. A gap exists between an end of the pressing bump and the light receiving surface. The button cap has a pressed surface and an accommodating space, and he button cap covers the light guide body, such that the light guide body is disposed in the accommodating space and combined with the button cap. The pressed surface has at least one through hole fitted by the light exiting structure of the light guide body. The light exiting structure is exposed on the the pressed surface by passing through the through hole.

In one or more embodiments, the present invention further provides an illumination switch assembly, which includes a substrate, a light source, a switch element, and an illumination button. The light source is disposed on the substrate for projecting light. The switch element is disposed on the substrate and used for being touched to generate a switch signal. A gap exists between the light source and the switch element. The illumination button is disposed on the substrate and keeps a gap from the substrate. The illumination button is used for being moved back and forth along a movement axis, so as to be close to or far away from the substrate. The switch element is located at the movement axis. The pressing bump of the illumination button is located at the movement axis for pressing the switch element. The light receiving structure receives the light from the light source, such that the light is guided and exits the light guide body and the top surface of the button cap through the light exiting structure.

In the present invention, the light receiving structure and the pressing bump are formed on the light guide body separately, such that the pressing bump having an optimal triggering effect when pressing the switch element. At the same time, after the light guide body receives the light, the light is directly guided to the light exiting structure and exits by means of the through hole of the button cap, so as to enhance an illumination effect on the button cap. In addition, the through hole and light exiting structure also do not suffer from the problem that pigment is abraded and drops off.

In the prior art, the manufacturing process of fixing the button cap through welding also impedes subsequent re-work or button cap replacement.

In order to solve the above problem, the present invention is further directed to a button structure having a quickly removable button cap, which can be fast assembled without tools, and facilitates re-work or button cap replacement.

In one or more embodiments, the present invention provides a button structure, which includes a housing, two clamping members, and a button cap. The housing has a button hole for communicating an outer surface and an inner surface of the housing. The clamping members are disposed on the inner surface of the housing, and the button hole is located between the two clamping members. The button cap is located in the button hole, and has a pressed surface. The pressed surface is exposed on the outer surface of the housing through the button hole. Connecting members are disposed to an edge of the button cap and extend in opposite directions along a radial direction of the button cap respectively, and are used for being clamped by the clamping members, so as to hold the button cap at the button hole.

The clamping members fix the connecting members in a clamping manner, such that a welding tool or the like is not required for fixing the connecting member. At the same time, the connecting members may be detached from the clamping members to remove the button cap, thereby facilitating re-work or replacement of the button cap.

In one or more embodiments of the present invention, each of the connecting members includes a flexible connecting portion and a latched piece. The flexible connecting portion is connected at the edge of the button cap. The latched piece is indirectly connected to the button cap through the flexible connecting portion to be clamped by each clamping member. And a positioning column is disposed on the inner surface of the housing. At least one of the latched pieces has a positioning hole for the positioning column to pass through, thereby generating a fastening effect in a radial direction of the button cap.

In one or more embodiments of the present invention, each of the connecting members includes a flexible connecting portion and a ring. The flexible connecting portion is connected at the edge of the button cap. The ring is disposed at an end of the flexible connecting portion for the positioning column on the inside surface of the housing to pass through. Each clamping member has a clamping notch for clamping one of the flexible connecting portions.

In one or more embodiments of the present invention, each of the connecting members includes a flexible connecting portion and a ring. The flexible connecting portion is connected at the edge of the button cap. The ring is disposed at an end of the flexible connecting portion for the positioning column to pass through. Each of the clamping members has a positioning hook and a supporting portion. The positioning hook is disposed on the inner surface of the housing, and has an upper block for pressing against the flexible connecting portion and keeping the flexible connecting portion from being away from the housing. The supporting portion is disposed on the inner surface of the housing, and the positioning column is disposed on the supporting portion. The supporting portion is used for supporting the ring such that a gap is kept between the ring and the inner surface of the housing, thereby clamping the connecting member by the upper block and the supporting portion.

The clamping members fix the connecting members in a clamping manner, such that a welding tool or the like is not required for fixing the connecting members. At the same time, the connecting members may be detached from the clamping members to remove the button cap, thereby facilitating re-work or replacement of the button cap.

### BRIEF DESCRIPTION OF THE DRAWINGS

The present invention will become more fully understood from the detailed description given herein below for illustration only, and thus are not limitative of the present invention, wherein:

FIG. 1 is an exploded view of an illumination switch assembly according to a first embodiment of the present invention;

FIG. 2 is a perspective view of the illumination switch assembly according to the first embodiment of the present invention;

FIG. 3 is a perspective view of a light guide body according to the first embodiment of the present invention;

FIG. 4 is a perspective view of a button cap according to the first embodiment of the present invention;

FIG. 5 is a cross-sectional view of the light guide body separated from the button cap according to the first embodiment of the present invention;

FIG. 6 is a cross-sectional view of the light guide body, the button cap, a substrate, a switch element, and a light source according to the first embodiment of the present invention;

FIG. 7 is a perspective view of an illumination button according to the first embodiment of the present invention;

FIG. 8 is an exploded view of a button structure having a quickly removable button cap according to the first embodiment of the present invention;

FIG. 9 is a perspective view of the button structure having a quickly removable button cap according to the first embodiment of the present invention;

FIGS. 10 and 11 are cross-sectional views of the button structure having a quickly removable button cap according to the first embodiment of the present invention;

FIG. 12 is a perspective view of a clamping member according to a second embodiment of the present invention;

FIG. 13 is a perspective view of the clamping member according to the second embodiment of the present invention, in which the clamping member clamps a latched piece;

FIG. 14 is a perspective view of a clamping member according to a third embodiment of the present invention;

FIG. 15 is a perspective view of the clamping member according to the third embodiment of the present invention, in which the clamping member clamps a latched piece;

FIG. 16 is a perspective view of an illumination button according to a fourth embodiment of the present invention;

FIG. 17 is an exploded view of a button structure having a quickly removable button cap according to the fourth embodiment of the present invention;

FIG. 18 is a perspective view of the button structure having a quickly removable button cap according to the fourth embodiment of the present invention;

FIG. 19 is an exploded view of a button structure having a quickly removable button cap according to a fifth embodiment of the present invention; and

FIG. 20 is a cross-sectional view of a light guide body, a button cap, a substrate, a switch element, and a light source according to a sixth embodiment of the present invention.

### DETAILED DESCRIPTION

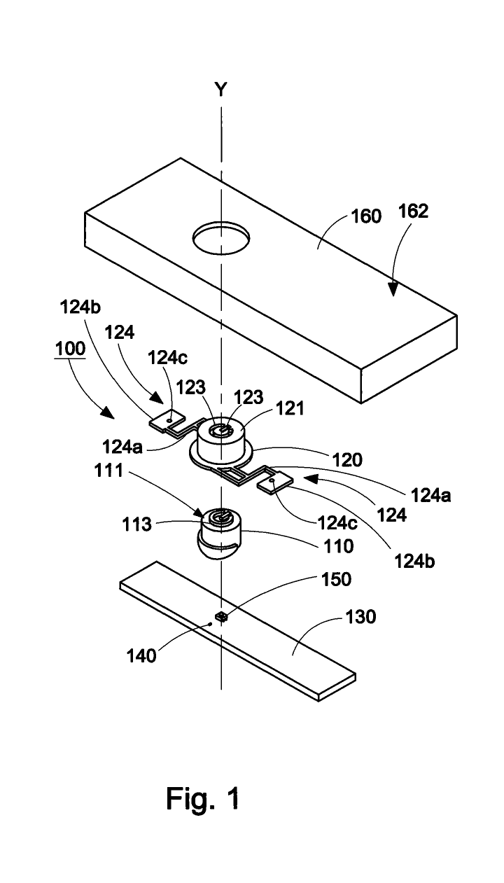

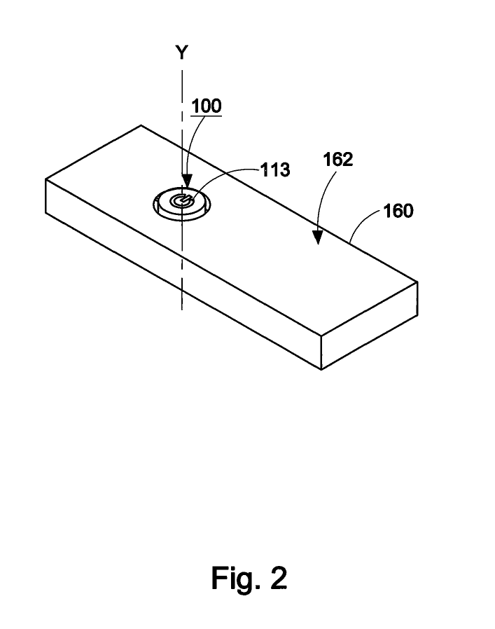

Referring to FIGS. 1 and 2, an illumination button 100 according to a first embodiment of the present invention shown, the illumination button 100 includes a light guide body 110 and a button cap 120. The light guide body 110 is combined with the button cap 120, and light can be received to highlight local pattern features.

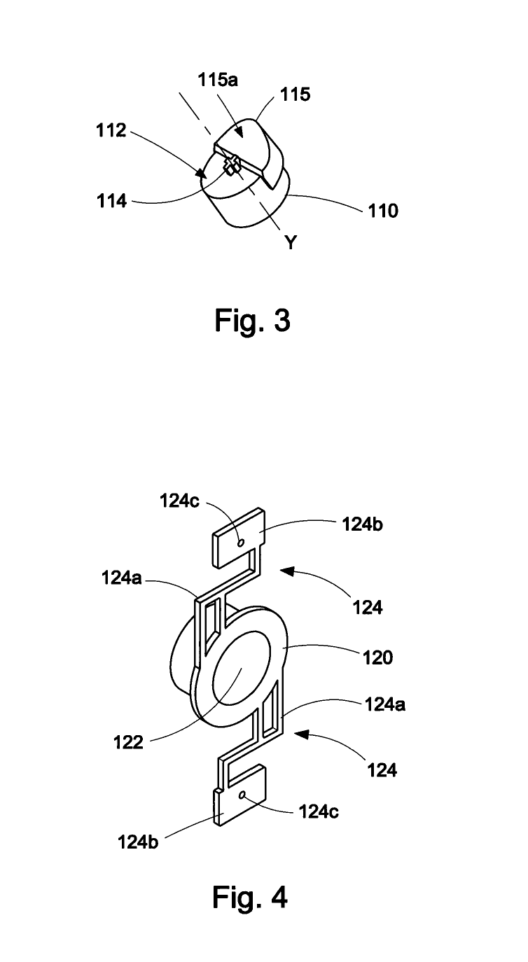

Referring to FIGS. 1 and 3, the light guide body 110 is made of light-pervious material.

However, the material is not limited to colorless light-pervious material. The material of the light guide body 110 may be a colorless light-pervious material mixed with pigment, such that only visible light of specific colors can pass through the material of the light guide body 110 to show a certain color.

The light guide body 110 has a top surface 111, a bottom surface 112, a protrusive light exiting structure 113, a protrusive pressing bump 114, and a protrusive light receiving structure 115. The light exiting structure 113 is formed on the top surface 112. The configuration a cross-sectional area of the light exiting structure 113 is a button symbol, for example, a symbol indicating power switch. Referring to FIG. 3, the pressing bump 114 and the light receiving structure 115 are formed on the bottom surface 112 of the light guide body 110. The pressing bump 114 is located substantially at a center of the bottom surface 112. The light receiving structure 115 extends in a direction departing from the center, such that a gap exists between the end of the pressing bump 114 and the light receiving structure 115.

Referring to FIGS. 1 and 4, the button cap 120 includes a pressed surface 121 and an accommodating space 122. The button cap 120 also includes one or more through holes 123 formed on the pressed surface 121. Each through hole 123 is provided for being fitted by the light exiting structure 113 of the light guide body 110.

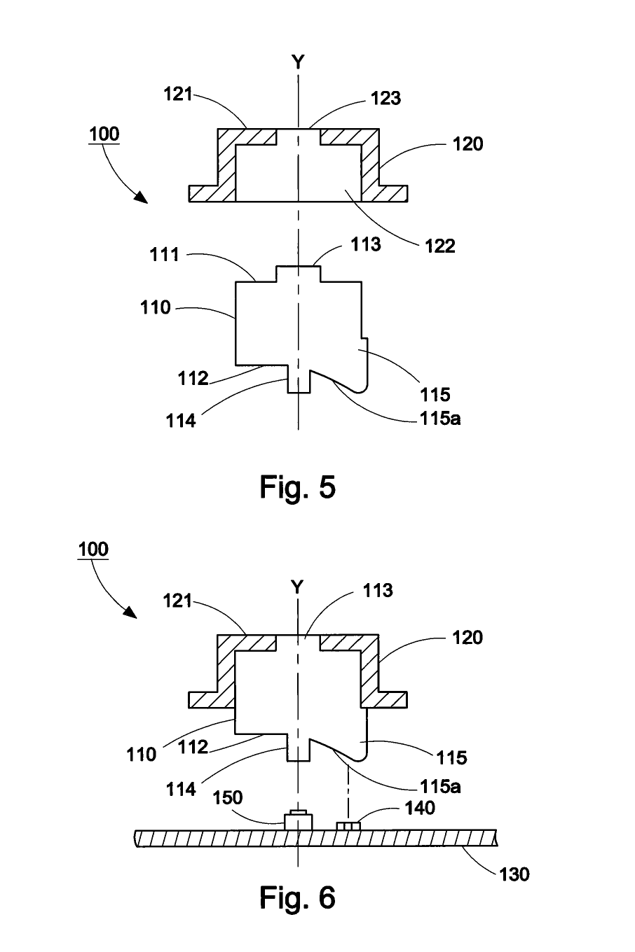

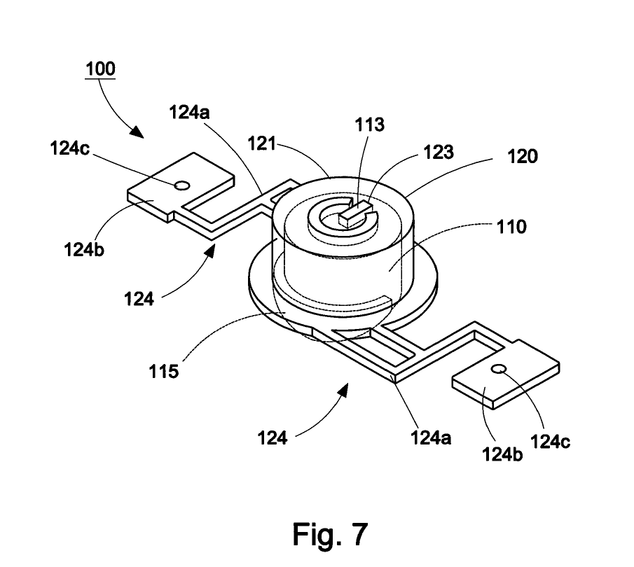

As shown in FIGS. 5, 6, and 7, the button cap 120 covers the top surface 111 of the light guide body 110, such that the light guide body 110 is located in the accommodating space 122 and disposed in the button cap 120. The light exiting structure 113 of the light guide body 110 is exposed on pressed surface 121 of the button cap 120 by passing through the through hole 123.

The pressing bump 114 and the light receiving structure 115 extend in different directions. In general, the illumination button 100 is provided to be moved back and forth along a movement axis Y. The movement axis Y passes through the top surface 111 and the bottom surface 112 of the light guide body 110. The pressing bump 114 protrudes from the bottom surface 112 along the movement axis Y. The light receiving structure 115 has at least one light receiving surface 115a. A gap exists between the end of the pressing bump 114 and the light receiving surface 115a. The light receiving surface 115a is disposed far away from the movement axis Y, thus ensuring that the pressing bump 114 is located at the movement axis Y.

Referring to FIGS. 1 and 6, an illumination switch assembly is also provided according to the first embodiment of the present invention. The illumination switch assembly includes a substrate 130, a light source 140, a switch element 150, and the illumination button 100 described above.

The substrate 130 may be a printed circuit board or a common board equipped with wires for carrying the light source 140 and the switch element 150 and providing power and signal transmission.

The light source 140 and the switch element 150 are disposed on the substrate 130. The light source 140 is used for projecting a light. The switch element 150 is used for being pressed to generate a switch signal. Further, another gap exists between the light source 140 and switch element 150.

Referring to FIGS. 1 and 6 again, the illumination button 100 is disposed above the substrate 130 through support of other fastening mechanisms, and is spaced from the substrate 130 at a gap, such that the light source 140 and the switch element 150 are located between the illumination button 100 and the substrate 130. At the same time, the gap is maintained to ensure that the switch element 150 is not pressed by the illumination button 100 when the illumination button 100 is not pressed. As described above, the illumination button 100 is moved back and forth along the movement axis Y, so as to be close to or far away from substrate 130. The movement axis Y is perpendicular to a surface of the substrate 130, and the switch element 150 is located at the movement axis Y. When the illumination button 100 is pressed and moves towards the substrate 130, the pressing bump 114 of the light guide body 110 presses the switch element 150, such that the switch element 150 generates the switch signal.

The light source 140 is an element such as a light-emitting diode (LED) or a miniature bulb. A light receiving surface 115a of the light receiving structure 115 of the light guide body 110 faces the light source 140, so as to receive light projected by the light source 140. The light enters the light guide body 110 through the light receiving surface 115a. After repetitive refraction and reflection, the light is guided by the light guide body 110 and exits the light guide body 110 through the light exiting structure 113. The light receiving structure 113 is exposed on the pressed surface 121 of the button cap 120, and the light may enable the light exiting structure 113 to illuminate, such that the pressed surface 121 of the button cap 120 is at least partly illuminated and displays a pattern of a button symbol.

Although the light guide body 110 and the button cap 120 are two separate elements in the accompanying drawings and the above description, in practice, through injection molding technologies such as double injection or multiple injection, the light guide body 110 and the button cap 120 made of different materials are directly combined through a single injection molding step, and a process for combining the light guide body 110 within the button cap 120 manually is no longer required.

The button symbol shows a configuration defined by the through hole 123 and the light exiting structure 113, and no pigment is abraded and drops off. Thus, the button symbol does not become indistinguishable due to abrasion of the illumination button 100. In addition, the illuminative light may be directly guided to the light exiting structure 113 and exit by means of the through hole 123. As a result, good illumination effect may also be achieved.

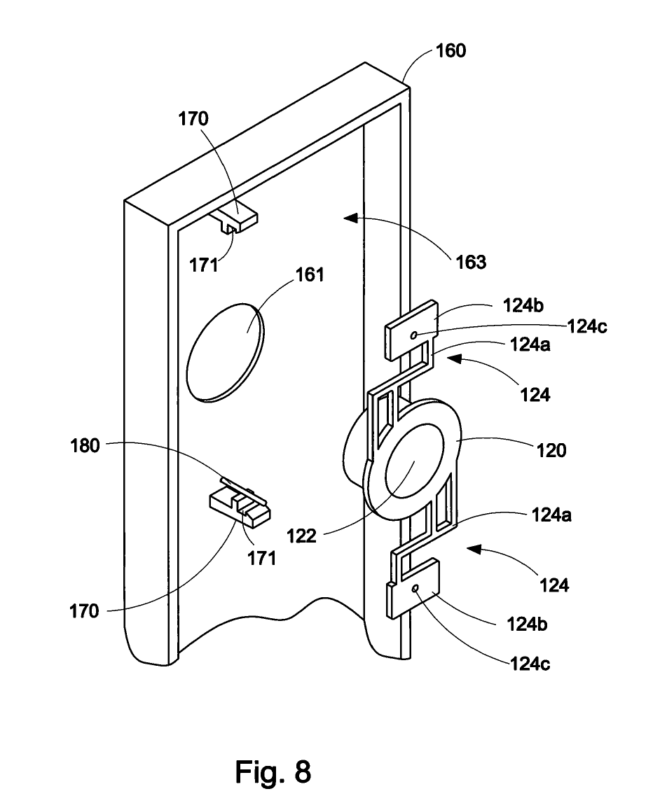

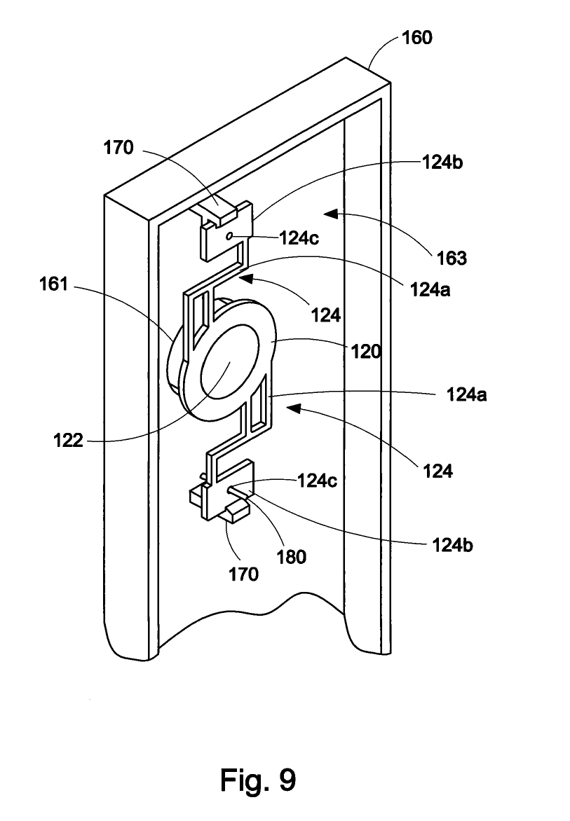

As shown in FIGS. 1, 2, 8, and 9, in order to install or remove the button, in the first embodiment, a button structure is provided. The button structure includes a housing 160, two clamping members 170, a positioning column 180, and an illumination button 100. In order to simplify the drawings, only the button cap 120 is shown for the illumination button 100 in FIGS. 8 and 9.

The housing 160 has a button hole 161 which communicating an outer surface 162 and an inner surface 163 of the housing 160. Two clamping members 170 are disposed on the inner surface 163 of the housing 160. The button hole 161 is located between the two clamping members 170.

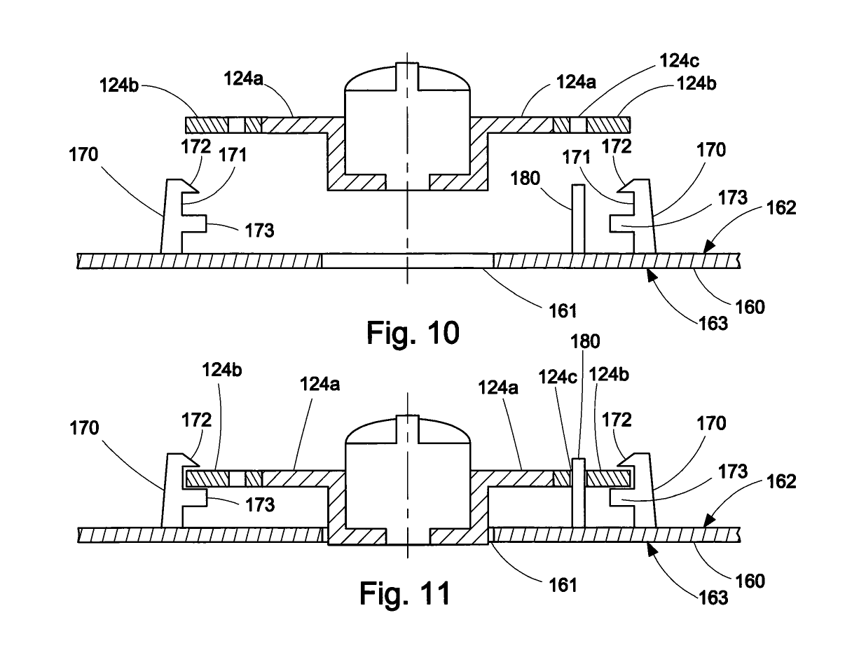

As shown in FIGS. 10 and 11, each clamping member 170 is a column-like structure disposed on the inner surface 163 of the housing 160. Each clamping member 170 has a clamping notch 171. The clamping notch 171 of one clamping member 170 faces the clamping notch 171 of the other clamping member 170. Each clamping member 170 further includes an upper block 172 and a lower block 173, which are disposed on a side surface of the clamping member 170, such that the clamping notch 171 is defined between the upper block 172 and the lower block 173. A slope is formed on an outer surface of the upper block 172, which is used for guiding an object to slide into the clamping notch 171. The positioning column 180 is disposed on the inner surface 163 of the housing 160 and located between one clamping member 170 and the button hole 161.

The illumination button 100 further includes two connecting members 124 disposed on an edge of the button cap 120. The two connecting members 124 extend in opposite directions along a radial direction of the button cap 120 respectively, and are clamped by the clamping members 170, so as to hold the button cap 120 at the button hole 161. Each connecting member 124 includes a flexible connecting portion 124a and a latched piece 124b. The flexible connecting portions 124a of the two connecting members 124 are monolithically connected at the edge of the button cap 120, and extend in opposite directions along the radial direction of the button cap 120 respectively. The flexible connecting portion 124a may be a single narrow sheet structure, a combination of a plurality of single sheet structures, or a zigzag narrow sheet structure. The latched piece 124b is indirectly connected to the button cap 120 through the flexible connecting portion 124a, and is used for being clamped by each the clamping member 170. At least one of the latched pieces 124b has a positioning hole 124c.

As shown in FIGS. 8, 9, 10, and 11, the button cap 120 is located in the button hole 161, such that the pressed surface 121 of the button cap 120 and the light exiting structure 115 of the light guide body 110 are exposed on the outer surface 162 of the housing 160 through the button hole 161. Meanwhile, the button hole 161 may restrict radial displacement of the button cap 120, avoiding excessive radial vibration of the button cap 120. At the same time, this design prevents the latched piece 124b being driven by the button cap 120 in the radial direction and dropping off from the clamping notch 171 of the clamping member 170. The positioning column 180 passes through a positioning hole 124c of one latched piece 124b, thereby further restricting the displacement of the button cap 120 in a radial direction, and directly avoiding horizontal movement of the latched piece 124b.

To make the latched piece 124b be clamped in the clamping notch 171, the edge of the latched piece 124b is first contacted with the slope of the upper block 172, and a force is applied to urge the latched piece 124b to move towards the inside surface of the housing 160. In such a manner, the latched piece 124b drives the two clamping members 170 to deform outwardly, such that the edge of the latched piece 124b may slide into the clamping notch 171. Therefore, the illumination button 100 is rapidly assembled in the housing 160, and no tool is required in the assembly process.

The clamping member 170 fixes the latched piece 124b in a clamping manner. The illumination button 100 can be disassembled by only outwardly deforming the clamping member 170. If the illumination button 100 is damaged and needs to be replaced but the housing 160 is not damaged and can still be used, a user may directly damage the illumination button 100 (for example, cut the flexible connecting portion 124a off), such that the damaged illumination button 100 is rapidly removed.

The flexible connecting portion 124a may deform flexibly. When the pressed surface 121 of the button cap 120 is pressed such that the illumination button 100 moves towards the interior of the housing 160, the flexible connecting portion 124a is bent and stretched under a force, so as to generate a elastic force driving the button cap 120 of the illumination button 100 towards the outside of the face housing 160. Therefore, when the pressed surface 121 is no longer pressed, the elastic force drives the button cap 120 to restore an original position.

As shown in FIGS. 1 and 2, the substrate 130 of the illumination switch assembly is disposed inside the housing 160, such that the light source 140 and the switch element 150 are located in the housing 160, so as to form a structure of the housing 160 for an electronic device having the illumination button 100.

Through the illumination button 100 disclosed in the first embodiment of the present invention, the switch element 150 may still be located on the movement axis Y of the illumination button 100, so as to generate an optimal pressing effect on the switch element 150. Guided by the light receiving structure 115, the light projected by the light source 140 reaches a center of the button cap 120 and exits through the through hole 123, so as to achieve an optimal illumination effect.

As shown in FIGS. 8 and 9, in the first embodiment of the present invention only one positioning column 180 is provided; however, in practice the two connecting members 124 are in a symmetric structure, the positioning holes 124c may be disposed at the latched pieces 124b of both the two connecting members 124. As such, the problem of matching the latched pieces 124b with the positioning column 180 does not need to be considered during installation of the illumination button 100, because each of the latched pieces 124b has a positioning hole 124c through which the positioning column 180 may pass.

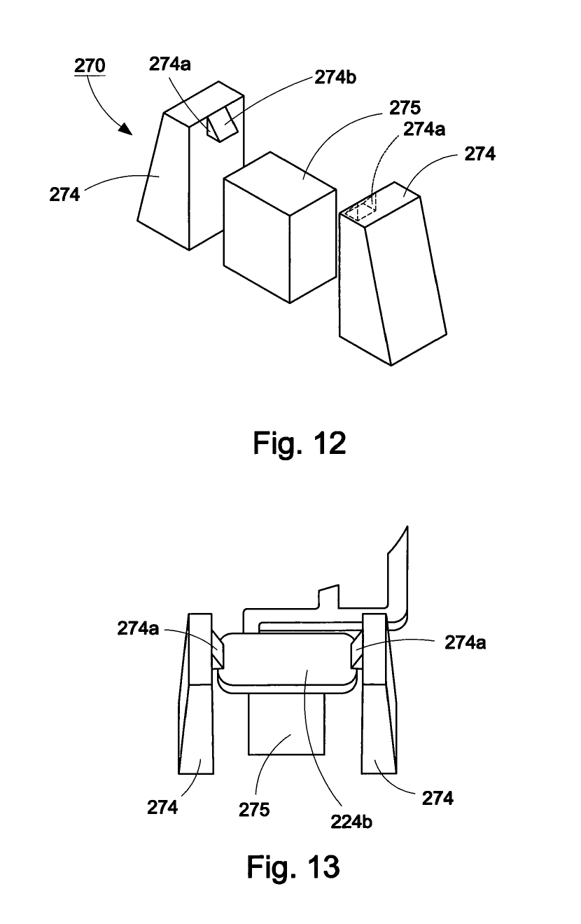

As shown in FIGS. 12 and 13, in a second embodiment, the present invention provides a clamping member 270 applicable to a button structure having a quickly removable button cap. The clamping member 270 includes two positioning hooks 274 and a supporting portion 275. The positioning hooks 274 are disposed on an inner surface of a housing in pair. The supporting portion 275 is disposed on the inner surface of the housing and located between the two positioning hooks 274. Each of the two positioning hooks 274 has an upper block 274a. A slope 274b is formed on an outer surface of the upper block 274a, and is used for guiding an object to slide and push the positioning hook 274 outwardly. The upper blocks 274a of the two positioning hooks 274 are used for pressing against the an upper surface of the latched piece 224b, and the supporting portion 275 is used for contacting a lower surface of the latched piece 224b to support the latched piece 224b, thereby clamping and fixing the latched piece 224b.

The supporting portion is not limited to a block structure, but can also be a cylinder, and the positioning column can be monolithically formed in the supporting portion.

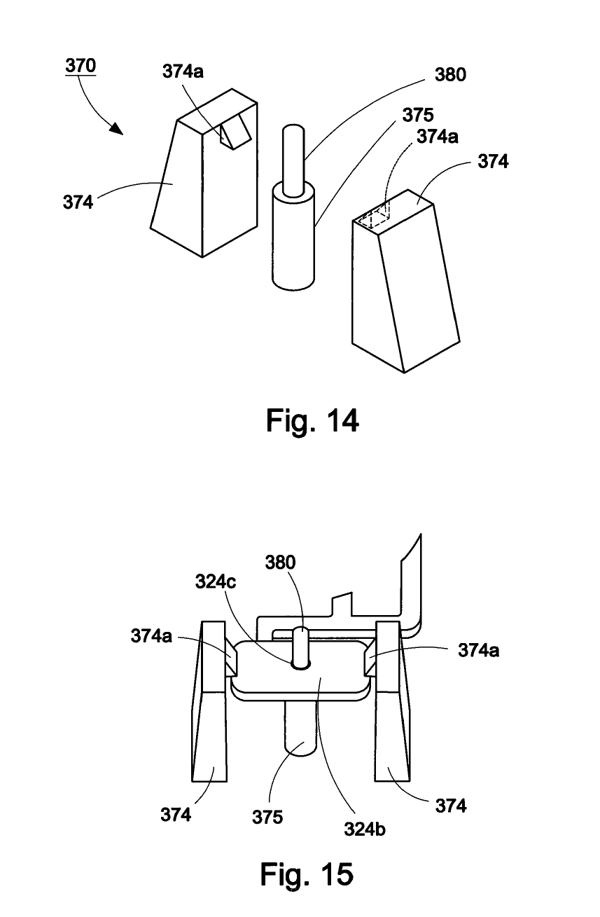

As shown in FIGS. 14 and 15, in a third embodiment, the present invention provides a clamping member 370 applicable to a button structure having a quickly removable button cap. The clamping member 370 includes two positioning hooks 374 and a supporting portion 375. The positioning hooks 374 are disposed on the inner surface of the housing in pair. The supporting portion 375 is disposed on the inner surface of the housing and located between the two positioning hooks 374. The supporting portion 375 is a cylinder having an outer diameter greater than an internal diameter of the positioning hole 324c of the latched piece 324b. The positioning column 380 is monolithically formed on a top surface of the supporting portion 375. Upper blocks 374a of the two positioning hooks 374 press against the upper surface of the latched piece 324b, and a top of the supporting portion 375 contacts the lower surface of the latched piece 324b and supports the latched piece 324b, thereby clamping the latched piece 324b. In addition, the positioning column 380 located at the top of the supporting portion 375 passes through the positioning hole 324c, thereby further restricting displacement of the button cap 320 in a radial direction. As the outer diameter of the supporting portion 375 is greater than the internal diameter of the positioning hole 324c, the supporting portion 375 does not pass through the positioning hole 324c, so as to support the latched piece 324b.

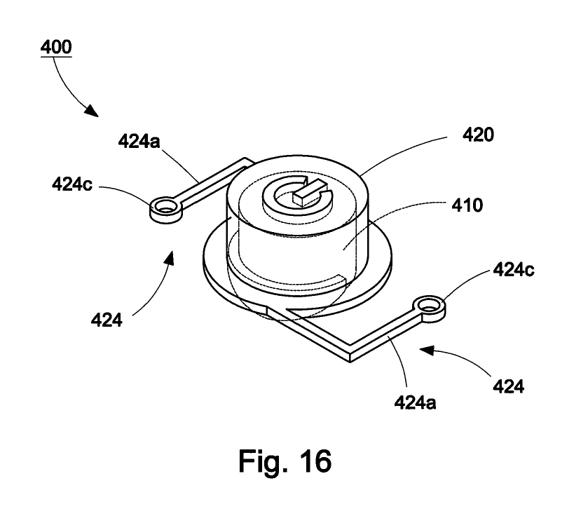

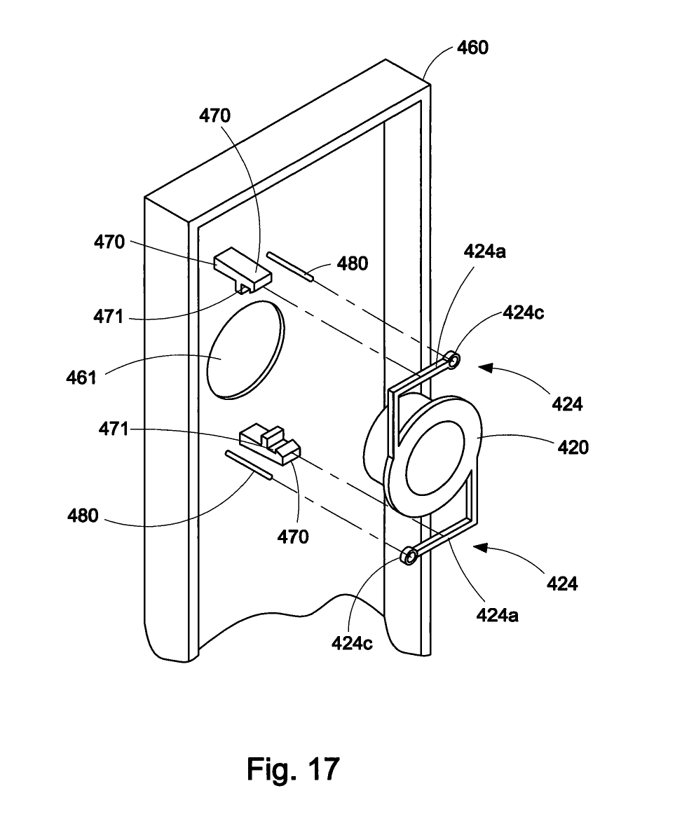

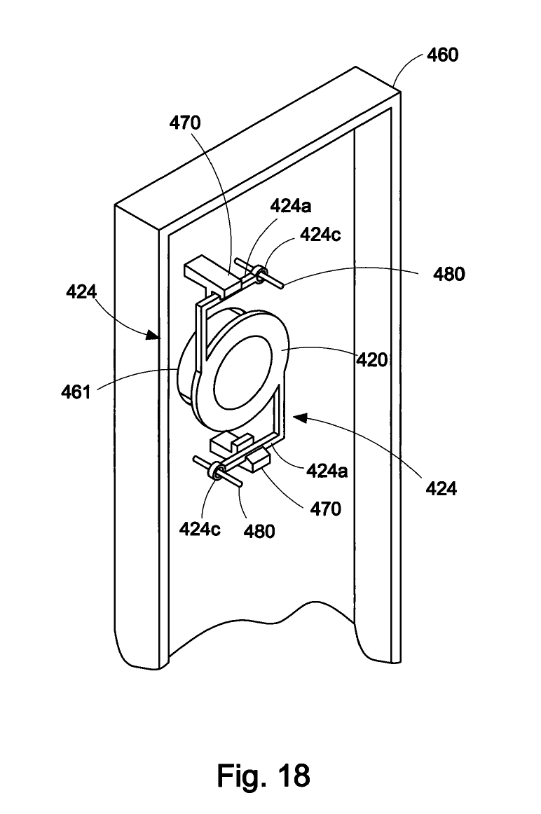

As shown in FIGS. 16, 17, and 18, in a fourth embodiment, the present invention provides a button structure having a quickly removable button cap, which includes a housing 460, two clamping members 470, two positioning columns 480, an illumination button 400, and two connecting members 424. The illumination button 400 includes a light guide body 410, a button cap 420, and two connecting members 424. The light guide body 410 and the button cap 420 are substantially the same as those in the first embodiment. However, the structure of the connecting members 424 is further simplified. Each connecting member 424 includes a flexible connecting portion 424a and a ring 424c. The flexible connecting portion 424a is monolithically connected at an edge of the button cap 420, and the flexible connecting portions 424a of the two connecting members 424 extend in opposite directions along a radial direction of the button cap 420 respectively. The flexible connecting portion 424a may be a single narrow sheet structure, a combination of a plurality of single narrow sheet structures, or a zigzag narrow sheet structure. The ring 424c is disposed at an end of the flexible connecting portion 424a.

Each clamping member 470 is substantially the same as the clamping member in the first embodiment, which has a clamping notch 471 respectively and used for clamping the flexible connecting portion 424a, thereby supporting the button cap 420 at the button hole 461. At the same time, the positioning columns 480 pass through the rings 424c, thereby further confining the displacement of the button cap 420 in the radial direction.

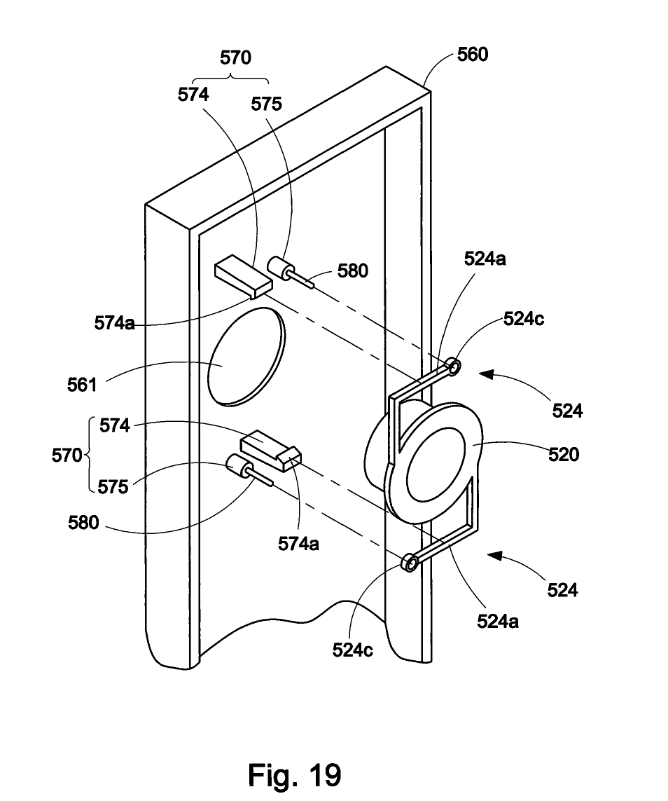

As shown in FIG. 19, in a fifth embodiment, the present invention provides a button structure having a quickly removable button cap, which includes a housing 560, two clamping members 570, two positioning columns 580, an illumination button, and two connecting members 524. The structures of the illumination button and the connecting members 524 are substantially the same as those in the fourth embodiment, and will not be described again here.

Each clamping member 570 includes a positioning hook 574 and a supporting portion 575, respectively. The supporting portion 575 is a cylinder having an outer diameter greater than an internal diameter of the ring 524c. The positioning column 580 is monolithically formed on the supporting portion 575. The upper blocks 574a of the two positioning hooks 574 are used for pressing against the flexible connecting portions 524a to keep the the flexible connecting portions 524a from being far away from the housing 560. The supporting portions 575 are used for supporting the rings 524c. Therefore, the connecting members 524 are clamped, so as to support the button cap 520 at the button hole of the housing 560. At the same time, the positioning columns 580 located at the top of the supporting portions 575 pass through the rings 524c, thereby further confining the displacement of the button cap 520 in the radial direction.

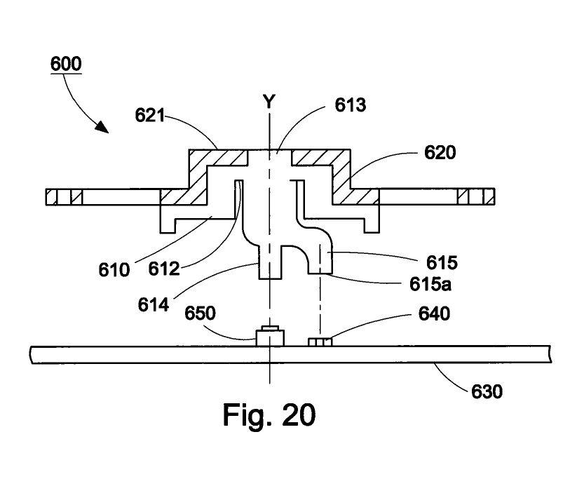

As shown in FIG. 20, in a sixth embodiment the present invention provides an illumination switch assembly, which includes an illumination button 600, a substrate 630, a light source 640, and a switch element 650.

The illumination button 600 includes a light guide body 610 and a button cap 620. In the sixth embodiment, a bottom surface 612 of the light guide body 610 is a bottom plane of a depression, and the light receiving structure 615 protrudes at a center of the bottom surface 612 and extends along a direction far away from the movement axis Y, such that the light receiving surface 615a is far away from the movement axis Y. The pressing bump 614 is formed on the light receiving structure 615 and extends along the movement axis Y, such that a gap exists between the end of the pressing bump 614 and the light receiving surface 615a.

The bottom surface 612 in the depression enables the light guide body 610 to be a thin shell, thereby reducing the material needed for fabricating the light guide body 610. The light receiving structure extends from the center of the bottom surface, and can still guide light to the top surface of the light guide body 610 directly, such that the light exits the light guide body 610 from the light exiting structure 613, thus keeping the light-guiding efficiency of the light guide body 610. The pressing bump 614 is still located on the movement axis Y, so a good pressing effect is maintained.

While the present invention has been described by the way of example and in terms of the preferred embodiments, it is to be understood that the invention is not limited to the disclosed embodiments. On the contrary, it is intended to cover various modifications and similar arrangements. Therefore, the scope of the appended claims should be accorded the broadest interpretation so as to encompass all such modifications and similar arrangements.

What is claimed is:

1. An illumination button, comprising:
a light guide body, made of light-pervious material, comprising:
a top surface and a bottom surface;
a light exiting structure formed on the top surface;
a protrusive pressing bump formed on the bottom surface; and
a protrusive light receiving structure formed on the bottom surface, and having a light receiving surface for receiving a light, and a gap exiting between an end of the pressing bump and the light receiving surface, wherein the light is guided by the light guide body and exits from the light exiting structure; and
a button cap, covering the light guide body, and comprising:
an accommodating space, in which the light guide body being located in the accommodating space and combined with the button cap; and
a pressed surface, having at least one through hole fitted by the light exiting structure of the light guide body, and the light exiting structure being exposed on the pressed surface through the through hole.

2. The illumination button as claimed in claim 1, wherein a configuration of a cross-sectional-area of the light exiting structure is a configuration of a button symbol.

3. The illumination button as claimed in claim 1, further comprising two connecting members, disposed on an edge of the button cap, and extending in opposite directions along a radial direction of the button cap respectively.

4. The illumination button as claimed in claim 3, wherein each of the connecting members comprises a flexible connecting portion and a latched piece, the flexible connecting portion is connected at the edge of the button cap, and the latched piece is indirectly connected to the button cap through the flexible connecting portion.

5. The illumination button as claimed in claim 3, wherein each of the connecting members comprises a flexible connecting portion and a ring, the flexible connecting portion is connected at the edge of the button cap, and the ring is disposed at an end of the flexible connecting portion.

6. An illumination switch assembly, comprising:
a substrate;
a light source, disposed the substrate for projecting light;
a switch element, disposed on the substrate and for being pressed to generate a switch signal and, a gap existing between the light source and the switch element; and
an illumination button, for being moved back and forth along a movement axis to be close to or far away from the substrate; the switch element being located at the movement axis, and the illumination button comprising:
a light guide body, made of light-pervious material, comprising:
a top surface and a bottom surface;
a light exiting structure formed on the top surface;
a protrusive pressing bump formed on the bottom surface and located at the movement axis for pressing the switch element; and
a protrusive light receiving structure formed on the bottom surface, and having a light receiving surface for receiving a light, wherein the light is guided by the light guide body and exits from the light exiting structure; and
a button cap, covering the light guide body, and comprising:
an accommodating space, in which the light guide body being located in the accommodating space and combined with the button cap; and
a pressed surface, having at least one through hole fitted by the light exiting structure of the light guide body, and the light exiting structure being exposed on the pressed surface through the through hole.

7. The illumination switch assembly as claimed in claim 6, further comprising two connecting members, disposed on an edge of the button cap, and extending in opposite directions along a radial direction of the button cap respectively.

8. The illumination switch assembly as claimed in claim 7, wherein each of the connecting members comprises a flexible connecting portion and a latched piece, the flexible connecting portion is connected at the edge of the button cap, and the latched piece is indirectly connected to the button cap through the flexible connecting portion.

9. The illumination switch assembly as claimed in claim 7, wherein each of the connecting members comprises a flexible connecting portion and a ring, the flexible connecting portion is connected at the edge of the button cap, and the ring is disposed at an end of the flexible connecting portion.

10. A button structure, comprising:
a housing, having a button hole communicating an outer surface and an inner surface of the housing;
two clamping members, disposed on the inner surface of the housing with the button hole located between the two clamping members;
a button cap, located at the button hole, and having a pressed surface exposed from on the outer surface of the housing through the button hole; and
two connecting members, disposed an edge of the button cap, extending in opposite directions along a radial direction of the button cap respectively, to be clamped by the clamping members respectively to hold the button cap in the button hole.

11. The button structure as claimed in claim 10, wherein each of the connecting members comprises a flexible connecting portion and a latched piece, the flexible connecting portion is connected to an edge of the button cap, and the latched piece is indirectly connected to the button cap through the flexible connecting portion for being clamped by each of the clamping members.

12. The button structure as claimed in claim 11, wherein each of the clamping members has a clamping notch, and the clamping notch of one of the clamping member faces the clamping notch of the other clamping member for clamping the latched pieces respectively.

13. The button structure as claimed in claim 12, wherein each of the clamping members further comprises an upper block and a lower block disposed on a side surface of the clamping member, and the clamping notch is defined between the upper block and the lower block.

14. The button structure as claimed in claim 13, wherein a slope is formed on an outer surface of the upper block for guiding the corresponding latched piece to slide into the clamping notch.

15. The button structure as claimed in claim 11, wherein each of the clamping members comprises:
at least one positioning hook disposed on the inner surface of the housing, for pressing against an upper surface of the latched piece; and
a supporting portion disposed on the inner surface of the housing, for contacting a lower surface of the latched piece to support the latched piece.

16. The button structure as claimed in claim 15, further comprising at least one positioning column, disposed on a top surface of the supporting portion, and at least one of the latched pieces having a positioning hole for the positioning column to pass through.

17. The button structure as claimed in claim 10, wherein:
each of the connecting members comprises a flexible connecting portion connected at the edge of the button and a ring disposed at an end of the flexible connecting portion for a positioning column on an inside surface of the housing to pass through; and
each of the clamping members has a clamping notch for clamping the flexible connecting portion.

18. The button structure as claimed in claim 10, wherein:
each of the connecting members comprises a flexible connecting portion connected at the edge of the button and a ring disposed at an end of the flexible connecting portion for a positioning column to pass through; and
each of the clamping members comprises:
a positioning hook, disposed on the inner surface of the housing, having an upper block for pressing against the flexible connecting portion and the keeping flexible connecting portion from being far away from the housing; and
a supporting portion, disposed on the inner surface of the housing for supporting the ring, with the positioning column disposed on the supporting portion.

19. The button structure as claimed in claim 10, further comprising a light guide body, made of a light-pervious material, disposed in the button cap, and the light guide body comprising:
a top surface and a bottom surface;
a light exiting structure, formed on the top surface, passing through the pressed surface and exposed on the pressed surface.;
a protrusive pressing bump, formed on the bottom surface; and
a protrusive light receiving structure, formed on the bottom surface, has and having a light receiving surface for receiving a light, and a gap existing between an end of the pressing bump and the light receiving surface, wherein the light is guided and exits the light exiting structure.

20. The button structure as claimed in claim 19, further comprising:
a substrate, disposed in the housing;
a light source, disposed on the substrate, and for projecting light to a light receiving surface; and
a switch element, disposed on the substrate, and for being pressed by a pressing bump.
